(19) United States
(12) Patent Application Publication
(10) Pub. No.: US 2026/0095302 A1
(43) Pub. Date: Apr. 2, 2026

(54) Verification of Encrypted Data Without Access to Plaintext

(71) Applicant: Google LLC, Mountain View, CA (US)

(72) Inventors: Christopher John Terefinko, Brooklyn, NY (US); Shruti Jain, Bangalore (IN); Luiz Franca Pereira Filho, Jersey City, NJ (US); Peter James Solderitsch, Haverford, PA (US)

(21) Appl. No.: 19/069,670

(22) Filed: Mar. 4, 2025

(30) Foreign Application Priority Data
Oct. 2, 2024 (IN) 202411074512

(51) Int. Cl. H04L 9/06; H04L 9/32

(52) U.S. Cl. CPC H04L 9/0643; H04L 9/3247

(57) ABSTRACT

A computing system can include one or more processors and one or more example non-transitory computer-readable media storing instructions that are executable by one or more processors to cause the computing system to perform operations. The operations can include receiving, from a second computing system comprising one or more second computing devices, first cryptographic data indicative of at least one file modification. The operations can include receiving, from a third computing system comprising one or more third computing devices, second cryptographic data indicative of the at least one file modification. The operations can include providing, to the third computing system, verification data indicative of a correctness of metadata associated with the at least one file modification.

### CROSS-REFERENCE TO RELATED APPLICATIONS

The present application is based upon and claims the right of priority to Indian Provisional Patent Application No. 202411074512, filed on Oct. 2, 2024, the disclosure of which is hereby incorporated by reference herein in its entirety for all purposes.

### FIELD

The present disclosure relates generally to systems and methods for data verification. More particularly, the present disclosure relates to systems and methods for verifying encrypted data without access to corresponding unencrypted data.

### BACKGROUND

Cryptography includes a variety of systems and methods for ensuring the security or privacy of data. Cryptographic techniques can include, for example, encryption and decryption. Encryption can include, for example, converting readable data to a format that cannot be read without a decryption key. Decryption can include, for example, converting encrypted data back to a readable format using a decryption key. A cryptographic key can include, for example, a data item (e.g., secret string of binary bits) that can be used for encryption, decryption, or other cryptographic techniques.

Software as a service includes a variety of systems and methods for providing access to software (e.g., via the internet, etc.). In some instances, software can include software for manipulating (e.g., editing, updating, creating, deleting, transferring, etc.) or otherwise accessing one or more files (e.g., word processing files, spreadsheet files, slideshow presentation files, etc.). In some instances, a system for providing software as a service can include one or more server devices for storing one or more files. In some instances, access to the files can be shared between a plurality of client devices.

### SUMMARY

Aspects and advantages of embodiments of the present disclosure will be set forth in part in the following description, or can be learned from the description, or can be learned through practice of the embodiments.

Example aspects of the present disclosure provide an example first computing system that includes one or more processors and one or more example non-transitory computer-readable media storing instructions that are executable by one or more processors to cause a computing system to perform example operations. In some implementations, the example operations can include receiving, from a second computing system comprising one or more second computing devices, first cryptographic data indicative of at least one file modification. The example operations can include receiving, from a third computing system comprising one or more third computing devices, second cryptographic data indicative of the at least one file modification. The example operations can include providing, to the third computing system, verification data indicative of a correctness of metadata associated with the at least one file modification.

Example aspects of the present disclosure provide an example method. In some implementations, the example method can include modifying, by a first computing system comprising one or more first computing devices, one or more files. The example method can include cryptographically transforming, by the first computing system, first data comprising data indicative of the modifying to obtain a cryptographically transformed value. The example method can include sending, by the first computing system to a second computing system comprising one or more second computing devices, the cryptographically transformed value. The example method can include receiving, by the first computing system from the second computing system, a cryptographic verification value associated with the cryptographically transformed value. The example method can include providing, by the first computing system, the cryptographic verification value to one or more third computing devices.

Example aspects of the present disclosure provide one or more example non-transitory computer-readable media storing instructions that are executable by one or more processors to cause a computing system to perform example operations. In some implementations, the example operations can include obtaining one or more encrypted files. The example operations can include decrypting the one or more encrypted files to obtain one or more unencrypted working files, wherein the unencrypted working files comprise first data indicative of one or more prior modifications to the unencrypted working files. The example operations can include cryptographically transforming second data comprising all or part of the first data to generate a cryptographically transformed value. The example operations can include providing, to a computing system comprising one or more computing devices, the cryptographically transformed value and metadata associated with the one or more prior modifications. The example operations can include receiving, from the computing system, verification data indicative of an authenticity of the metadata.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram of an example environment in which systems and methods according to aspects of the present disclosure may be performed;

FIG. 2 is a block diagram of an example system for performing an example first aspect of an example verification protocol according to some aspects of the present disclosure;

FIG. 3 is a block diagram of an example system for performing an example second aspect of an example verification protocol according to some aspects of the present disclosure;

FIG. 4 is a block diagram of an example system for performing an example second aspect of an example verification protocol according to some aspects of the present disclosure;

FIG. 5 is a block diagram of an example system for performing an example first aspect of an example verification protocol according to some aspects of the present disclosure;

FIG. 6 is a flow chart diagram of an example method for providing metadata verification according to example implementations of aspects of the present disclosure;

FIG. 7 is a flow chart diagram of an example method for modifying a file according to example implementations of aspects of the present disclosure;

FIG. 8 is a flow chart diagram of an example method for receiving metadata verification according to example implementations of aspects of the present disclosure;

FIG. 9 is a block diagram of an example networked computing system according to example implementations of aspects of the present disclosure;

FIG. 10 is a block diagram of an example computing device according to example implementations of aspects of the present disclosure; and

FIG. 11 is a block diagram of an example computing device according to example implementations of aspects of the present disclosure.

### DETAILED DESCRIPTION

Generally, the present disclosure is directed to systems and methods for cryptographic data verification. More particularly, the present disclosure is directed to systems and methods for providing server-side verification of content contained in one or more encrypted files, without providing the server with direct access to unencrypted content of the one or more files. For example, in some instances, users of a cloud computing software service (e.g., Google Docs, Google Sheets, Google Slides, etc.) may wish to store encrypted files on a cloud computing server, without allowing the server itself to decrypt or otherwise access unencrypted data stored in the file. For example, in some instances, a group of users (e.g., employees of a business, etc.) may wish to share a file with each other, but may wish to keep data stored in the file otherwise confidential. In such instances, the group of users may choose to store an encrypted file on a cloud computing server, and may choose to share a decryption key with each other (e.g., using a key control service separate from the cloud computing service, etc.)

However, in some instances, a group of users may also wish to receive server-side verification of various kinds of data associated with (e.g., stored in) a shared file. As a non-limiting illustrative example, a word processing file may have a feature that allows users to add comments to the file (e.g., add a comment associated with a particular sentence or paragraph); add edit suggestions or make reversible edits to the file; or otherwise interact with the word processing file. Continuing the non-limiting illustrative example, the word processing file may store data correlating a file interaction (e.g., comment, edit, suggestion, etc.) with a particular user who performed the interaction. Continuing the example, a group of users (e.g., employees of a company) may wish to receive independent server-side verification of which user performed each interaction with the file. For example, the group of users may wish to prevent a malicious group member (e.g., employee) from adding “fake” comments with fraudulent or otherwise inaccurate attribution data making the comment appear to come from another person. However, if the server does not have access to the unencrypted contents of the file, providing independent server-side verification of the contents of the file may be difficult.

According to some example aspects of the present disclosure, systems and methods are described for providing independent server-side verification of content stored in one or more encrypted files, without providing the server with direct access to unencrypted content stored in the one or more files. For example, in a first aspect of an example protocol, a first computing device (e.g., client device) can modify a file and provide cryptographic data (e.g., hash data) based on the modification to a second computing device (e.g., server device). The second computing device can generate a cryptographic verification value (e.g., cryptographic digital signature) based on the cryptographic data received from the first computing device, without accessing the unencrypted modification itself. In a second aspect of the example protocol, a third computing device (e.g., additional client device) can verify the authenticity of the file modification based on the cryptographic verification value.

For example, in some implementations of the first aspect, the first computing device can modify a file and generate a cryptographic value (e.g., hash value) based on the modification using a cryptographic function (e.g., hash function, etc.). As a non-limiting illustrative example, if the first computing device adds a paragraph to a word processing file, the first computing device can generate the cryptographic value based on all or part of the paragraph added. As another example, if the first computing device deletes a row from a spreadsheet file, the first computing device can generate the cryptographic value based on data indicative of the deletion, such as a row index of the row that was deleted, etc. In some instances, the cryptographic value can be based in part on other data, such as metadata associated with the modification. As a non-limiting illustrative example, if the first computing device adds a paragraph to a document at 8:57 a.m., the first computing device can bundle an 8:57 a.m. timestamp with the added paragraph and generate a cryptographic value based on the bundled data.

In some implementations, the second computing device can generate a cryptographic signature based in part on cryptographic data received from the first computing device and based in part on additional unencrypted data that is available to the second computing device. For example, in some instances, the second computing device can combine the cryptographic data received from the first computing device with various kinds of additional data, and generate a cryptographic signature based on the combined data. In some instances, the additional data can include data that has been independently verified by the second computing device (e.g., server), such as a current timestamp indicating what time the cryptographic data was received; a username or user identifier indicating a user that was logged in from the first computing device when the cryptographic data was received; a filename or file identifier associated with the file being modified; or any other data that a group of users may wish to receive independent server-side verification of.

According to a second aspect of an example protocol, the cryptographic signature generated by the second computing device can be used to verify various kinds of data associated with the file modification made by the first computing device. For example, in some implementations, the first computing device can modify the file, encrypt it, and send the encrypted modified file to be stored on the server. A third computing device may receive the encrypted modified file from the server, decrypt it, and notice that the unencrypted file shows a modification made by the first computing device. The third computing device can generate a cryptographic value (e.g., hash value) based on the modification using the same cryptographic function used by the first computing device as described above. The third computing device and first computing device can share a cryptographic key, such that the cryptographic value generated by the third computing device should be identical to the cryptographic value generated by the first computing device (assuming nothing has been tampered with). The third computing device can then provide the new cryptographic value (e.g., hash value) to the second computing device, and the second computing device can generate a new cryptographic signature based at least in part on the new cryptographic value. For example, the second computing device can generate a new cryptographic signature based on the new cryptographic value and various kinds of additional data, such as a user who allegedly performed the file modification; a time stamp; or any other data for which a group of users may wish to receive independent server-side verification. If the new cryptographic signature matches the old cryptographic signature, then the new additional data can be independently verified by the server as (1) accurate, (2) associated with the file modification made by the first computing device, and (3) the same as the prior additional data used to generate the prior cryptographic signature.

The cryptographic signatures, the additional data to be verified, and other kinds of data can be stored or transmitted in various ways. For example, in some example implementations, the first computing device can add the modification data (e.g., comment, edit, etc.), a copy of the cryptographic signature (e.g., received from the second computing device), and a copy of any additional data to be verified (e.g., username, timestamp, etc.) to the unencrypted file before encrypting the file and transmitting the encrypted modified file to the server. The server can provide the encrypted modified file to the third computing device. The third computing device can generate a new cryptographic hash value based on the modification data. The third computing device can provide, to the server, the new hash value, a copy of the old cryptographic signature, and a copy of the additional data to be verified. The server device can generate a new cryptographic signature, compare it to the old cryptographic signature (e.g., provided by the third computing device), and provide the third computing device with a yes-or-no answer indicating whether the cryptographic signatures match. However, this exact combination is not required. For example, a server can provide the new cryptographic signature to the third device, and the third computing device can perform the comparison. As another example, the additional data and cryptographic signature may be stored or transmitted in another manner, such as stored on the server in a format that is accessible to the server (e.g., unencrypted format, encrypted using a key the server has access to, etc.); stored in a different file separate from the modified file; etc.

In some instances, a second computing device (e.g., server device) can separately provide independent verification of two or more sets of additional data. For example, in some instances, the second computing device can generate a first cryptographic signature based on a hash value received from the first computing device and a first set of additional data. The second computing device can generate a second cryptographic signature based on the same hash value and a second set of additional data. Later, the third computing device can then use the two cryptographic signatures to separately verify the first and second sets of additional data values. As a non-limiting illustrative example applying such multi-set verification, some example software applications (e.g., web-browser-based word processor application, etc.) may permit copying content (e.g., user comments) from a first file to a second file. In such instances, some copied content may be associated with a file identifier that does not match the file the content is stored in. This may not be indicative of malicious activity (e.g., a malicious user adding a “fake” file identifier) and may instead be an innocent result of permitted copying. In such instances, a group of users may wish to separately verify file identifier data. If a file identifier does not match, a software application may display an alert saying, “This comment appears to be copied from another file. ” In contrast, if other data does not match (e.g., user identifier, etc.), a software application may display a more serious alert message or even refuse to display the file or file modification (e.g., comment) to a user.

An example field of application for aspects of the present disclosure can include a server providing software as a service. Example software can include various kinds of software configured to modify one or more files, such as word processing software (e.g., Google Docs), spreadsheet software (e.g., Google Sheets), slideshow presentation software (e.g., Google Slides), image editing software, audio or video editing software, human resources software, customer relationship management software, database software, data entry software, or any other software that can modify files. In some instances, the server can store encrypted files to be shared between a plurality of client devices. In some instances, the client devices can have access to a shared decryption key (e.g., via a key management service that may be separate from the software server), which may be unavailable to the server. In some instances, the server may be configured to provide independent verification of various kinds of content within the files. For example, in some instances, the server may verify, for each of a plurality of file modifications associated with a file, user data associated with the modification. In some instances, the server may verify other data, such as timestamp data, file identifier data, or any other data a group of users may wish to verify. Other fields of application are possible.

Systems and methods of the present disclosure can provide a variety of technical effects and benefits, such as improvements to server-side data verification technology; data security or data privacy technology; and computing technology. For example, in some instances, example systems and methods according to some aspects of the present disclosure can provide improved data security or privacy compared to some alternative data verification methods. In some instances, systems and methods according to some aspects of the present disclosure can provide improved data verification compared to some alternative methods for encrypting and storing encrypted files. In some instances, systems and methods can provide data verification and data security at a reduced computational cost (e.g., electricity cost, memory cost, processor usage, etc.) compared to some alternative methods.

For example, systems and methods according to some aspects of the present disclosure can provide improved data security or data privacy compared to some alternative methods for server-side verification of file modification data. For example, in some instances, alternate methods for providing server-side data verification may require a server to access unencrypted plaintext associated with the data being verified. Such a method may require the server to store the data in an unencrypted format or to store a decryption key to decrypt the data periodically (e.g., whenever a client device seeks verification, etc.). However, storing data in an unencrypted format, or storing a decryption key to regularly generate unencrypted data, can increase a risk of data breaches from malicious actors. In addition, allowing a server to access data in an unencrypted format may in some instances directly violate a data security policy or privacy policy associated with the data. For example, some data (e.g., patient health data, student education data, confidential business data, etc.) may be subject to strict confidentiality or privacy rules, which may prohibit unencrypted disclosure to a software-as-a-service provider. Advantageously, systems and methods according to example aspects of the present disclosure can provide server-side verification of some file modification data (e.g., attribution of particular edits or comments to particular users, etc.) without giving the server access to underlying unencrypted data. In this manner, for instance, data security or data privacy can be improved compared to some alternate server-side verification methods.

Similarly, systems and methods according to some aspects of the present disclosure can provide improved server-side verification features compared to alternate methods for providing secure data storage (e.g., encrypted file storage without server access to a decryption key). For example, some alternate secure encryption methods may provide no server-side verification at all because ordinary methods for providing server-side verification (e.g., verification of individual modifications within a file) may depend on server access to unencrypted data. Advantageously, systems and methods according to example aspects of the present disclosure can provide server-side verification of some file modification data (e.g., attribution of particular edits or comments to particular users, etc.) without giving the server access to underlying unencrypted data, thereby providing improved server-side verification compared to some alternative methods for ensuring data security or data privacy.

Additionally, systems and methods according to some aspects of the present disclosure can provide reduced computational cost (e.g., electricity cost, memory usage, processor usage, data transmission bandwidth, etc.) compared to some alternative methods of providing server-side verification of file modification data of an encrypted file. As a non-limiting illustrative example, an example alternative method may include storing an encrypted file on the server, and fully decrypting the file each time a client device opens the file; modifies the file; requests verification of one or more modifications to the file; or the like. In such instances, repeated server-side decryption may not only increase various data security or data privacy risks, but may also require the server to use various computational resources (e.g., processor resources, memory resources, electricity, etc.) to decrypt the data and store the decrypted data in memory (e.g., volatile memory such as random access memory (RAM)). Advantageously, systems and methods according to some aspects of the present disclosure can provide verification at reduced computational cost compared to some alternative methods.

Additionally, systems and methods according to example aspects of the present disclosure can comprise individual components (e.g., method components, system components, etc.) that may each individually provide a variety of benefits (e.g., technical benefits, practical benefits, etc.) to one or more users or owners of client-side computing devices; one or more users or owners of server-side computing devices; and various other parties. For example, in some instances, a user or owner of a client or server device may benefit directly from a technical benefit (e.g., technical benefit described above, such as improved data security, improved data verification, etc.) or practical benefit provided directly by an example component according to example aspects of the present disclosure. For example, a group of users or another entity (e.g., business organization) associated with a plurality of client devices may receive a direct practical benefit (e.g., improved data security or privacy, improved confidence in user attribution data or other data stored in an encrypted file, prevention or detection of improper file modifications, etc.) from any component described herein that may contribute to data security, data verification, and the like. Client device users may also directly benefit from other aspects of disclosed systems and methods, such as storing encrypted files on a server device; sharing encrypted files between a plurality of client devices; receiving access to software according to a software-as-a-service implementation; or the like. As another example, an entity associated with a server computing device (e.g., software as a service provider) may receive a direct practical benefit from any component described herein that may contribute to reduced server-side computational cost compared to alternative methods for providing data verification or data security.

Additionally, in some instances, providing a practical or technical benefit directly to a first person (e.g., user or owner of a client device) may provide an indirect practical or technical benefit to a second person (e.g., user or owner of a server device) interacting with the first person (e.g., in a contractual or business interaction, etc.). As a non-limiting illustrative example, preventing a server device from reading encrypted file data may directly benefit a client-side user, group, or organization by protecting client-side data, and may also benefit a server-side owner by increasing client users' willingness to use the server device to store encrypted files, which can provide various practical benefits (e.g., business-related benefits, such as increased revenue from file storage subscriptions or advertising, improved public perception or reputation, etc.) to a server-side owner. For example, providing a benefit to a customer may increase customer satisfaction; increase the customer's willingness to return for repeat business; improve the seller's reputation and therefore its ability to attract new customers; increase a price a customer is willing to pay for a service comprising the benefit; or the like. Similarly, it will be understood that providing a benefit to a seller can inherently provide a benefit to a customer of the seller by reducing a price at which the seller is able or willing to sell; incentivizing the seller to provide improved services, additional features, or improved contractual terms (e.g., non-monetary contractual terms) to the customer; or the like.

Additionally, in some instances, a first component of a system or method can provide a practical or technical benefit by providing a necessary prerequisite for a second component that provides a practical or technical benefit in combination with the first component. As a non-limiting illustrative example, if a method comprises transmitting data and then performing verification based on the data, any person or legal entity that benefits from the verification inherently benefits from transmitting the data, as transmitting the data was a necessary prerequisite for performing verification based on the data so transmitted.

Example components according to example aspects of the present disclosure that can provide example practical and technical benefits to users and owners of both client and server devices may include, but are not limited to, various components and benefits described in the next two paragraphs.

In some instances, independent server-side verification of data stored in an encrypted file, which can directly benefit a user or owner of one or more client-side devices and can indirectly benefit a server-side user or owner, can be provided or contributed to by each of the following: cryptographically transforming first data indicative of a file modification; transmitting, to a server, a resulting cryptographically transformed value; receiving, from the server, a cryptographic verification value associated with the modification; providing the cryptographic verification value to one or more other client devices (e.g., by adding it to the modified file, which can be stored in encrypted form on a server and shared between client devices); cryptographically transforming, by a second client device, second data indicative of the file modification; providing, to the server, a resulting second cryptographically transformed value; receiving, from the server, verification data (e.g., a cryptographic verification value; other verification data based on a server-side comparison between first and second cryptographic verification values; verification data indicative of a correctness of metadata; etc.); performing a cryptographic hash or cryptographic signature; receiving, by a server device, cryptographically transformed values and generating verification data (e.g., cryptographic verification values, other verification data, etc.) based on the received values; verifying specific categories of metadata, which may be categories of interest to a group of client-side users or other entity (e.g., user attribution metadata, timestamp metadata, file identifier metadata, etc.); obtaining various kinds of data used in other components (e.g., metadata, cryptographically transformed values, file modification data, cryptographic verification values, etc.) from various sources (e.g., files, user inputs, etc.); or the like.

In some instances, increased data security of encrypted file data, which can directly benefit a user or owner of one or more client-side devices and can indirectly benefit a server-side user or owner, can be provided or contributed to by each of the following: encrypting a file before sending the encrypted file to a server (e.g., using a key that is not accessible to the server); decrypting the file after receiving the encrypted file from the server; or the like. In some instances, various other practical and technical benefits (e.g., access to useful or beneficial software, etc.), which can directly benefit a user or owner of one or more client-side devices and can indirectly benefit a server-side user or owner, can be provided by each of the following: modifying one or more files; storing encrypted files on a server to be shared between client devices; receiving encrypted files from the server; accessing software, or accessing or modifying files associated with useful software (e.g., word processing software, spreadsheet software, slideshow presentation software); or the like.

Various example implementations are described herein with respect to the accompanying Figures.

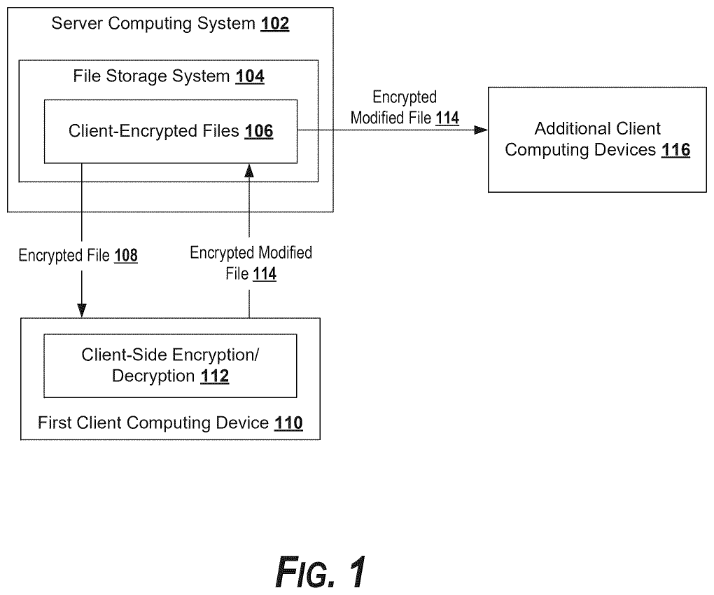

FIG. 1 is a block diagram of an example environment in which systems and methods according to aspects of the present disclosure may be performed. A server computing system 102 comprising one or more server computing devices may store one or more client-encrypted files 106 in a file storage system 104. The server computing system 102 may provide an encrypted file 108 to a first client computing device 110. The first client computing device 110 may decrypt the file using client-side encryption/decryption 112; make one or more modifications to the decrypted file; encrypt the modified file using client-side encryption/decryption 112; and transmit the encrypted modified file 114 to the server computing system 102 to be stored in the file storage system 104. Later, the server computing system 102 can provide the encrypted modified file 114 to one or more additional client computing devices 116.

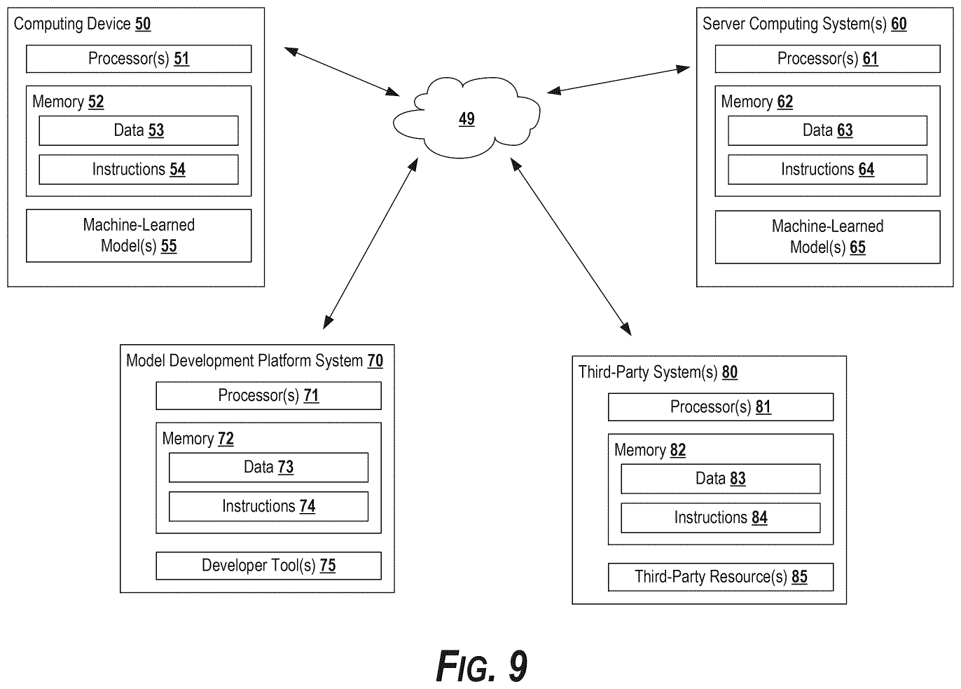

A server computing system 102 can be or include one or more software, firmware, or hardware components configured to store client-encrypted files 106 or perform one or more other activities described herein. In some instances, the server computing system 102 can be, comprise, be comprised by, or share one or more properties with a computing device or system described below with respect to FIGS. 9-11 (e.g., server computing system 60, computing device 98, computing device 99, etc.). In some instances, a server computing system 102 can include one or more software, firmware, or hardware components configured to provide access to software as a service to one or more client devices. For example, the server computing system 102 can include one or more non-transitory computer-readable media storing instructions that, when executed by the server computing system 102, cause the server computing system 102 to perform operations for providing software as a service. Example operations for providing software as a service can include providing computer-readable instructions (e.g., browser-executable software code, etc.) to one or more client devices to cause the client devices to execute a client-side software application (e.g., browser-based software application to execute computer-readable instructions on a client device using a web browser, software application comprising instructions to perform one or more example operations described herein, etc.); providing one or more files configured to be used by a client-side software application; receiving one or more files (e.g., files associated with a client-side software application) for storage on the server computing system 102; or the like.

File storage 104 can be or include one or more software, firmware, or hardware components configured to store client-encrypted files 106. In some instances, file storage 104 can comprise hardware associated with a computing device or system described below with respect to FIGS. 9-11 (e.g., server computing system 60, computing device 98, computing device 99, etc.). For example, in some instances, file storage 104 can comprise a hard disk drive, solid state drive, or other nonvolatile or semi-volatile storage media associated with a server computing system 60.

Client-encrypted files 106 can include one type or many types of files. A server computing system 102 can store client-encrypted files 106 for one client device or many client devices; for one user or many users; and for one group of clients or users or many groups of clients or users (e.g., business organizations, families, friend groups, etc.). In some instances, a client-encrypted file 106 can include a file that was encrypted by a client device 110, 116 and transmitted by the client device 110, 116 to a server computing system 102. In some instances, a client-encrypted file 106 can be encrypted using computer-readable instructions provided to the client device 110, 116 by the server computing system 102 (e.g., browser-based software application), or using computer-readable instructions that were not provided to the client device 110, 116 by the server computing system 102.

In some instances, a client-encrypted file 106 can be a file that was encrypted using an encryption key that is not known by and not otherwise available to the server computing system 102. For example, in some instances, a client-encrypted file 106 can include a file that was encrypted using a shared encryption key that is shared between a plurality of client devices 110, 116, wherein the shared encryption key is unavailable to the server computing system 102. For example, in some instances, a plurality of client devices 110, 116 may interact with a key-management server, which can be different from the server computing system 102. For example, the key-management server may be owned or otherwise controlled by an entity (e.g. business organization, etc.) that is different from an entity that controls the server computing system 102. In some instances, a key-management entity can be the same as or different from an entity that controls one or more client devices 110, 116. In some instances, a key-management server can maintain an access control list (ACL) identifying which users or client devices are permitted to access a shared key, and can provide the shared key to such devices or users (e.g., when the users are appropriately logged in according to a security protocol, etc.) in response to a request for the shared key. However, this is not required. For example, a client-encrypted file 106 can be encrypted based on a key that is stored locally on one or more client devices 110, 116; shared between client devices 110, 116 in a peer-to-peer manner; or provided to a client device 110, 116 in any other manner without deviating from the scope of the present disclosure.

In some instances, client-encrypted files 106 can include file structures or directory structures for organizing a plurality of files, such as one or more folders; directories (e.g., directories comprising a plurality of folders in a hierarchical tree structure); archive files (e.g., zip, tar, gzip, compressed archive file, etc.); or the like. Data stored in the client-encrypted files 106 can generally include or otherwise represent various types of data. Data stored in the client-encrypted files 106 can include one type or many different types of data. Example data types can include text data, word processing data, or natural language data; numerical data; binary data; structured data (e.g., data object, data table, data row, data column, XML or JSON data, etc.); audio data; image data; video data; or the like. The client-encrypted files 106 can include any appropriate file type. Example file types can include word processing files (e.g., Google Docs, etc.), spreadsheet files (e.g., Google Sheets files, etc.), slideshow presentation files (e.g., Google Slides files, etc.), portable document format (PDF) files, communication files (e.g., email, text message, etc.), calendar files, media files (e.g., image, audio, video, etc.), data files (e.g., database files, customer relationship management or human resources data files, etc.), or the like. Although client-encrypted files 106 are expressly depicted in FIG. 1, a file storage 104 system can also store a variety of additional files, such as unencrypted files or files encrypted by a server computing system 102, without deviating from the scope of the present disclosure.

In some instances, a server computing system 102 can control access to files on the file storage system 104 using various means (e.g., instead of or in addition to encryption). For example, in some instances, a server computing system 102 can maintain one or more access control lists comprising data indicating which users, client devices 110, 116, or other devices or entities (e.g., groups of users, etc.) are permitted to access one or more files, folders, directories, or the like. In some instances, the server computing system 102 can receive a request (e.g., from a client device 110, 116; from a user; etc.) to access a file (e.g., client-encrypted file 106); identify, responsive to the request, a user or device the request was received from; determine, based on an access control list, whether the identified user or device is permitted to access the file; and transmit, responsive to determining that the user or device is permitted to access the file, a copy (e.g., encrypted copy) of the file to the requester. In some instances, a server computing system 102 may maintain a plurality of access control lists associated with a plurality of files, folders, or the like. For example, in some instances, a server computing system 102 may maintain a first access control list indicative of a plurality of users (e.g., employees of a business organization, etc.) who are permitted to access a first folder or directory (e.g., associated with a business organization as a whole); a second access control list indicative of a plurality of users (e.g., employees of a department of the business organization, etc.) who are permitted to access a second folder, directory, or file (e.g., department directory); a third access control list indicative of one or more users (e.g., workers assigned to a particular project, etc.) who are permitted to access a third folder, directory, or file (e.g., project directory, etc.); and so on.

An encrypted file 108 can be, comprise, be comprised by, or otherwise share one or more properties with a client-encrypted file 106. For example, an encrypted file 108 can have any property described above with respect to a client-encrypted file 106. In some instances, an encrypted file 108 can include a file that has not yet been edited or otherwise modified by the first client computing device 110 after receiving the encrypted file 108 from the server computing system 102. However, an encrypted file 108 can include files that have been modified one or more times (e.g., by additional client computing devices 116; by a first client computing device 110 in an earlier iteration of the processes described herein; etc.) without deviating from the scope of the present disclosure.

A first client computing device 110 can be or include one or more software, firmware, or hardware components configured to decrypt or modify an encrypted file 108 or perform one or more other activities described herein. In some instances, the first client computing device 110 can be, comprise, be comprised by, or share one or more properties with a computing device or system described below with respect to FIGS. 9-11 (e.g., computing device 50, computing device 98, computing device 99, etc.). In some instances, the first client computing device 110 can be a different computing device from a device of the server computing system 102. In some instances, the first client computing device 110 can include one or more client devices, such as a workstation, desktop, laptop, smartphone, or the like.

In some instances, the first client computing device 110 can include one or more firmware, software, or hardware components configured to interact in various ways with a server computing system 102, such as a server computing system 102 for providing software as a service. For example, in some instances, a first client computing device 110 can include a web browser that, when combined with one or more computer-readable instructions for execution in a web browser, cause the first client computing device 110 to perform various operations. In some instances, the first client computing device 110 can locally store computer-readable instructions (e.g., as part of a software application) to perform various operations. In other instances, the first client computing device 110 can receive computer-readable instructions from a server computing system 102 that, when executed by the first client computing device 110 (e.g., using a web browser, etc.), cause the first client computing device 110 to perform various operations.

Example operations that can be performed by a first client computing device 110 include various file manipulation operations, such as providing a user of the first client computing device 110 with one or more interfaces (e.g., graphical user interfaces, command-line interfaces, voice interfaces, etc.) for creating, editing, viewing, previewing, printing, saving, deleting, or otherwise manipulating one or more files (e.g., any file type listed above with respect to a client-encrypted file 106 or encrypted file 108, etc.); manipulating one or more files according to a user input received via a user interface; performing automatic file manipulation operations (e.g., according to one or more automated rules); or the like. Example automatic file manipulation operations can include automated file backup or file saving operations (e.g., auto-saving a working file every n minutes while a user works on it, auto-saving a working file after each change to the file, automatically saving a backup version of a file each time a file is opened or saved, etc.), automated data security or access control operations (e.g., automatic encryption and decryption of encrypted files; automatically determining, responsive to a user login, which files the user is permitted to access; automatically determining, responsive to a user request to access a file, whether the user is permitted to access the file; etc.), automatic file creation or file editing operations (e.g., operations associated with maintaining a log file, such as adding log entries to the log file, etc.), or other automatic file manipulation operations. An automatic operation can be, for example, an operation that is performed by a first client computing device 110 (e.g., alone or in combination with a server computing system 102) without any input from a user, or without direct user input requesting the operation. As a non-limiting illustrative example, saving a file responsive to a user clicking “Save” can be considered a non-automatic operation responsive to a direct user input directly requesting the save. Continuing the non-limiting illustrative example, saving a file responsive to a different user input (e.g., user input adding a word, sentence, or paragraph to a word processing file, etc.) may be considered an automatic operation if it is responsive to a user input or user action that does not directly request saving the file.

A system for client-side encryption/decryption 112 can be or include one or more software, firmware, or hardware components configured to encrypt or decrypt one or more files (e.g., encrypted file 108, encrypted modified file 114, etc.). In some instances, client-side encryption/decryption 112 can be performed by a component (e.g., processor, etc.) of a first client computing device 110 or additional client computing device 116.

Client-side encryption and decryption can include, for example, two components of a reversible cryptographic transformation. For example, encryption can include a reversible cryptographic transformation that transforms input data (e.g., a file) having a usable format (e.g., readable format, plaintext format, etc.) to output data having a format that may be difficult or impossible to use (e.g., read) without reversing (e.g., decrypting) the cryptographic transformation. In some instances, encryption can be performed using an encryption key (e.g., shared encryption key). A reversible cryptographic transformation can include a transformation wherein the entire input data (e.g., in a readable or usable format such as a file stored in a file format consistent with a corresponding file type or file extension associated with the file) can be recovered (e.g., lossless recovery) based on the output data (e.g., encrypted file, etc.). For example, an encryption process can include a process that transforms a file into an encrypted file, which can be decrypted using a decryption key to generate a copy of the original unencrypted file. In some instances, a decryption key can be the same as or different from an encryption key (e.g., shared encryption key) used to encrypt the encrypted file 108. For example, in some instances, a plurality of client devices 110, 116 can perform symmetric encryption and decryption, wherein a shared encryption key used to encrypt a client-encrypted file 106 can also be used as a decryption key for decrypting the client-encrypted file 106. However, this is not required. In some instances, a plurality of client-encrypted files 106 (e.g., associated with a business organization or other group of users who share access to the plurality of client-encrypted files 106) can be encrypted using one encryption key that is common to all files of the plurality of client-encrypted files 106, or can be encrypted using a plurality of different encryption keys (e.g., one for each department of a business organization, one for each project, file folder, or any other grouping; etc.). Encryption and decryption can be performed, for example, according to any appropriate encryption and decryption algorithm, such as triple data encryption standard (triple DES), advanced encryption standard (AES), Blowfish, Twofish, block cipher, stream cipher, one-time pad (e.g., in combination with a mechanism for sharing one-time pads between client devices 110, 116, such as a key management service), symmetric encryption, asymmetric encryption (e.g., integer-based encryption, elliptic curve encryption, etc.), quantum encryption, or the like.

An encrypted modified file 114 can be, comprise, be comprised by, or otherwise share one or more properties with an encrypted file 108. For example, in some instances, an encrypted modified file 114 can have any property described herein with respect to an encrypted file 108, and vice versa. In some instances, an encrypted modified file 114 can include a file that has been modified by one or more computing devices (e.g., after it was first created or saved; after it was received from a server computing system 102 by the first client computing device 110; etc.), such as a file that has been modified by the first client computing device 110 after the file was received from a server computing system 102.

An additional client computing device 116 can be or include one or more software, firmware, or hardware components configured to decrypt an encrypted modified file 114 or perform one or more other activities described herein. In some instances, the first client computing device 110 can be, comprise, be comprised by, or share one or more properties with a computing device or system described below with respect to FIGS. 9-11 (e.g., computing device 50, computing device 98, computing device 99, etc.). In some instances, an additional client computing device 116 can be a different computing device from the first client device 110. In some instances, an additional client computing device 116 can include one or more client devices, such as a workstation, desktop, laptop, smartphone, or the like. In some instances, an additional client computing device 116 can have any property described herein with respect to a first client computing device 110, and a first client computing device can have any property described herein with respect to an additional client computing device 116. For example, in some instances, a single client device can act as a first client computing device 110 in some circumstances (e.g., immediately upon modifying a file, etc.) and can act as an additional client computing device 116 in other circumstances (e.g., upon decrypting an encrypted modified file 114, etc.).

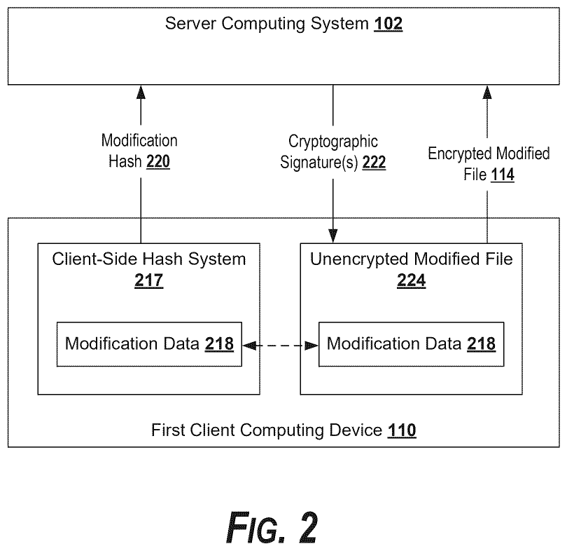

FIG. 2 is a block diagram of an example system for performing an example first aspect of an example verification protocol according to some aspects of the present disclosure. A first client computing device 110 can modify a file. The first client computing device 110 can use a client-side hash system 217 to generate a modification hash 220 based at least in part on modification data 218 describing the file modification. The first client computing device 110 can provide the modification hash 220 to a server computing system 102, which can generate one or more cryptographic signatures 222 based at least in part on the modification hash 220. In some instances, the cryptographic signature(s) 222 and the modification data 218 can be added to an unencrypted modified file 224. The first client device 110 can then encrypt the unencrypted modified file 224 to generate an encrypted modified file 114, which can be provided to a server computing system 102 for storage.

A client-side hash system 217 can be or include one or more software, firmware, or hardware components (e.g., components of a server computing system 102) configured to generate a modification hash 220 based on modification data 218.

Modification data 218 can generally include or otherwise represent various types of data. Modification data 218 can include one type or many different types of data. Example data types can include text data, word processing data, or natural language data; numerical data; binary data; structured data (e.g., data object, data table, data row, data column, XML or JSON data, etc.); audio data; image data; video data; or the like.

In some instances, modification data 218 can include content data that has been added, deleted, or edited (e.g., the text of a comment or added paragraph; marked-up text of an edited paragraph; etc.). In some instances, modification data 218 can include metadata associated with content data that has been added, deleted, or edited. Example metadata can include user data (e.g., username, user identification number, device identification data, login data, etc.) indicative of a user who performed or requested the modification; location data associated with a location of the modification within the file (e.g., paragraph number, word or sentence number, row index, column index, page number, slide number, pixel location, video timestamp, delimiter data, etc.) associated with the modification; a timestamp associated with the modification; categorical data describing a type of file modification that was made; device data associated with a device that requested or performed the modification (e.g., internet protocol address, geolocation data, architecture data such as hardware data, operating system data, software application data, etc.); or other metadata.

A file modification can include any act that changes the contents of one or more files. As a non-limiting illustrative example, a user may click a “thumbs up” reaction button (e.g., in association with a comment, paragraph, slide, spreadsheet row, or other data item the user would like to express approval for), and data indicative of the reaction may be stored in one or more files (e.g., the same file containing the content the user is reacting to; a different file from the file containing the content the user is reacting to; etc.). In such instances, the file containing the data indicative of the “thumbs up” reaction has been modified responsive to the user's reaction, and modification data 218 can include any data indicative of the “thumbs up” reaction (e.g., content identification data indicating which content the user is reacting to; user data indicating which user clicked the reaction button; modification type data indicating what type of modification was made, such as an “add thumbs up” modification type; or other data or metadata).

File modification data 218 can include data that is fully or only partially descriptive of a file modification. As a non-limiting illustrative example, file modification data 218 indicative of a “comment” added to a word processing file may include content from the comment itself, but may lack one or more other kinds of data added to the file in association with the comment (e.g., data that does not need to be verified; data that can be summarized, compressed, or otherwise safely reduced without impacting a verification process; nonprivate data that can be safely transmitted to the server in an unencrypted format; etc.).

In some instances, file modification data 218 can include a minimum usable description of the file modification, or may contain more data than is strictly necessary to describe a file modification. For example, in some instances, file modification data 218 can include an entire file (e.g., encrypted modified file 114, etc.) without going outside the scope of the present disclosure. For example, in some instances, file modification data 218 can include an entire file indicative of a current state of the modified file, which can be compared to past states of the file to determine what modifications have been performed. In principle, file modification data 218 can include any type or amount of data, provided that the file modification data 218 contains sufficient data to indicate (e.g., show, explain, provide sufficient data to determine, etc.) some information about what modification has been made. In some instances, the information about what modification has been made can be a complete or incomplete description of the modification. However, the file modification data 218 can in some instances include data sufficient to indicate (e.g., identify, determine, describe, show, etc.) all private or secure data (e.g., all data that is not revealed to a server computing system 102 in an unencrypted format) that one or more client computing devices 110, 116 is expected to receive server-side verification for without providing the private or secure data to the server computing system 102.

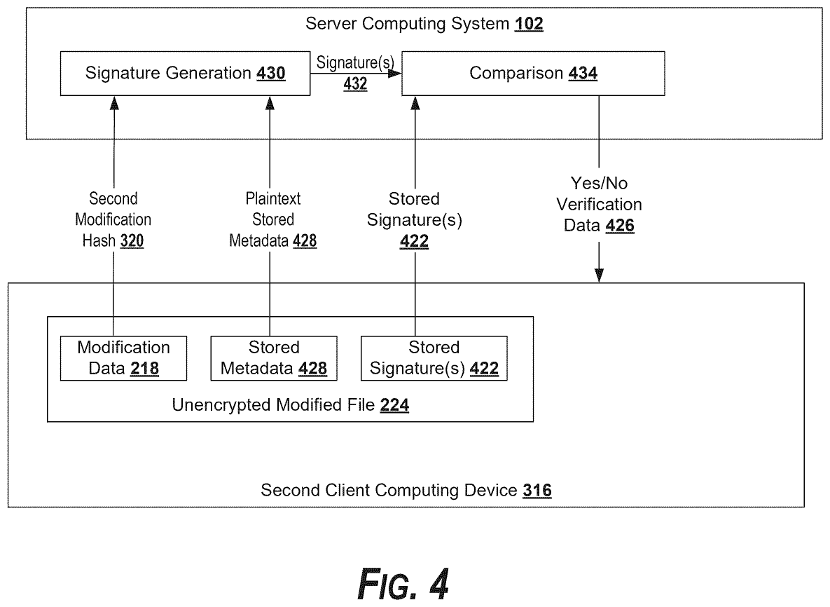

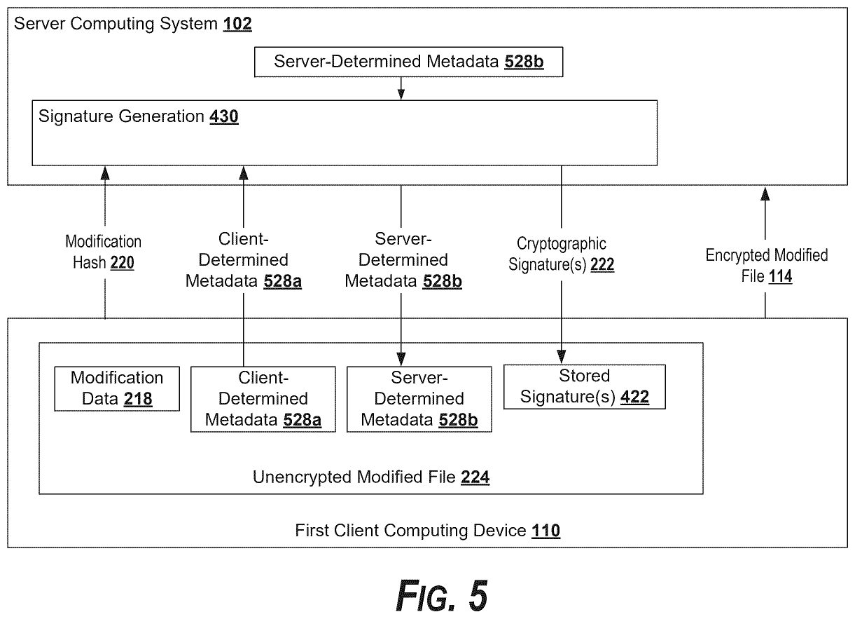

A modification hash 220 can include, for example, an output of a cryptographic transformation function (e.g., hash function) generated based at least in part on an input comprising the file modification data 218. In some instances, a modification hash 220 can include an output of a cryptographic transformation function based on an input comprising the file modification data 218, a cryptographic key (e.g., hash key such as shared hash key shared between a plurality of client devices), and additional data to be independently verified and correlated with the file modification data 218 by the server computing system 102. Further details of some example implementations for generating a modification hash 220 based on modification data 218 and additional data to be verified are provided below with respect to FIGS. 4 and 5.

In some instances, a modification hash 220 can be generated based on a shared cryptographic key (e.g., hash key, etc.) that is shared between a plurality of client devices 110, 116. In some instances, a shared key can be shared according to a key access control list (key ACL), key management server, or any other key-sharing mechanism (e.g., any mechanism described above with respect to encryption and decryption keys). Although the example implementation of FIG. 2 displays a modification “hash” 220, any cryptographic transformation can be used instead of or in addition to a hash without deviating from the scope of the present disclosure, such as reversible encryption; cryptographic digital signature generation; or any other cryptographic transformation that deterministically generates an output based on an input comprising file modification data 218. However, in some instances, a hash can advantageously provide a reduced size (e.g., in number of bytes) compared to some alternative cryptographic transformations (e.g., reversible encryption), thereby reducing a computational cost (e.g., data transmission bandwidth, electricity cost, etc.) of transmitting a modification hash 220 compared to some alternate methods. For example, in some instances, a hash function can include a function configured to generate a fixed-length output (e.g., a relatively short fixed-length output, such as a 128-bit, 224-bit, 256-bit, 384-bit, 512-bit, or 1024-bit output, etc.) regardless of a size of the input used to generate the hash. In this manner, for instance, a data size of the modification hash 220 can be reduced relative to encryption, wherein the output size may be directly proportional to a corresponding input size. In some instances, a cryptographic key for generating the modification hash 220 can be the same as or different from an encryption/decryption key used in client-side encryption 112.

In some instances, a cryptographic transformation function (e.g., hash function) used to generate the modification hash 220 can have various cryptographic properties. For example, a hash function can have an output probability that is uniform or nearly uniform over all possible output values (e.g., probability near 2⁻ⁿ for any given n-bit output of an n-bit fixed-output-length hash function). As another example, a hash function can include a hash function for which finding a new input value (e.g., with or without knowledge of a prior input value, such as modification data 218) that outputs a given output hash (e.g., modification hash 220) is computationally infeasible or significantly difficult (e.g., requiring many years of computation time to perform a brute force attack on a supercomputer, etc.). As another example, a hash function can include a hash function for which finding any two input strings that generate the same output hash is computationally infeasible or significantly difficult.

A cryptographic signature 222 can include any cryptographic verification value generated based at least in part on the modification hash 220. A cryptographic signature 222 can include, for example, a cryptographic transformation of data comprising the modification hash 220. In some instances, the data comprising the modification hash 220 can also include additional data, such as data to be independently verified by the server. Further details of some example implementations of cryptographic signatures 222 based on a modification hash 220 and additional data are provided below with respect to FIG. 5. In some instances, a cryptographic transformation can be based in part on a cryptographic key, such as a private key that is known to the server computing system 102 but not known to the first client computing device 110 (e.g., not known to any of the client devices 110, 116). In some instances, cryptographic signature 222 can comprise a digital signature generated using asymmetric cryptography. For example, a cryptographic signature 222 can include a digital signature generated by the server computing system 102 using a private key that is known only to the server computing system 102, wherein the authenticity of the digital signature can be verified by any person or device (e.g., using a public key that is complementary to the private key, wherein the public key is published or otherwise provided to the client computing devices 110, 116). Although FIG. 2 describes cryptographic “signature(s),” other cryptographic transformations (e.g., hash functions, reversible encryption, etc.) can be used without deviating from the scope of the present disclosure. A cryptographic signature 222 can be generated using any appropriate cryptographic function, such as Digital Signature Algorithm, Rivest-Shamir-Adleman encryption, elliptic-curve cryptography, or other cryptographic transformation function.

In some instances, a server computing system 102 can generate one cryptographic signature 222 or many cryptographic signatures 222 associated with a single modification hash 220. For example, in some instances, a server computing system 102 can generate a first cryptographic signature 222 based on the modification hash 220 and first additional data; a second cryptographic signature 222 based on the modification hash 220 and second additional data; and so on. As a non-limiting illustrative example, a server computing system 102 can generate a first cryptographic signature 222 based at least in part on user data associated with a user associated with the file modification (e.g., user account logged in using the first client computing device 110, etc.), and a second cryptographic signature 222 based at least in part on file data (e.g., filename, etc.) associated with the file that was modified. In this manner, for instance, a server computing system 102 and additional client device 116 can use a plurality of separate cryptographic signatures 222 to separately verify a plurality of data groupings (e.g., data comprising the user data; data comprising the file data; etc.).

In some instances, an unencrypted modified file 224 can be associated with, or share one or more properties with, an encrypted file 108 or encrypted modified file 114. For example, an unencrypted modified file 224 include a file generated from an encrypted file 108 (e.g., using a decryption key) or a file from which an encrypted modified file 114 is generated (e.g., using an encryption key, which may be the same as or different from a corresponding decryption key). Other than the files' status as encrypted or decrypted, an unencrypted modified file 224 can share any property described herein with respect to an encrypted file 108 or encrypted modified file 114. Similarly, other than the files' status as encrypted or decrypted, an encrypted file 108 or encrypted modified file 114 can share any property described herein with respect to an unencrypted modified file 224.

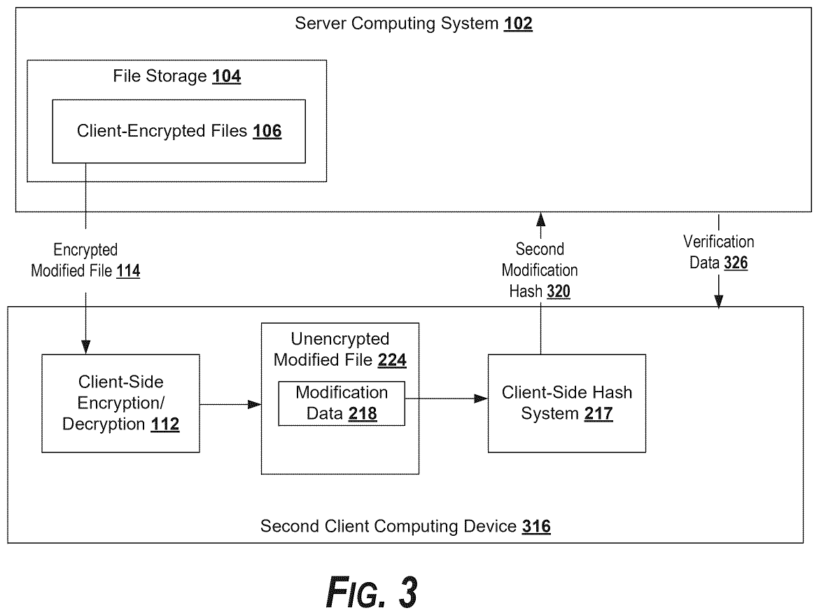

FIG. 3 is a block diagram of an example system for performing an example second aspect of an example verification protocol according to some aspects of the present disclosure. A server computing system 102 can provide an encrypted modified file 114 to a second client computing device 316. The second client computing device 316 can decrypt the file using client-side encryption/decryption 112 to generate an unencrypted modified file 224 comprising modification data 218. The second client computing device 316 can use a client-side hash system 217 to generate a second modification hash 320. The second client computing device 316 can provide the second modification hash 320 to the server computing system 102, which can generate verification data 326 based at least in part on the second modification hash 320.

A second client computing device 316 can be, comprise, be comprised by, or otherwise share one or more properties with an additional client computing device 116. For example, a second client computing device 316 can share any property described herein with respect to an additional client computing device 116, and vice versa.

A second modification hash 320 can be, comprise, be comprised by, or otherwise share one or more properties with a modification hash 220. For example, a second modification hash 320 can share any property described herein with respect to a modification hash 220, and vice versa. In some instances, a second modification hash 320 can include a hash generated by a computing device (e.g., second client computing device 316) that was not involved in making a file modification associated with modification data 218 used to generate the second modification hash 320.

Verification data 326 can generally include or otherwise represent various types of data. Verification data 326 can include one type or many different types of data. Example data types can include text data, word processing data, or natural language data; numerical data; binary data; structured data (e.g., data object, data table, data row, data column, XML or JSON data, etc.); audio data; image data; video data; or the like.

In some instances, verification data 326 can be, comprise, be comprised by, or otherwise share one or more properties with a cryptographic signature 222. For example, in some instances, one or more cryptographic signatures 222 can be provided directly to a second client computing device 316 as verification data 326. However, other types of verification data 326 are also possible, such as Boolean data, text data, error code data, numeric data, unencrypted or otherwise client-readable data (e.g., encrypted data for which a second client computing device 316 has a decryption key, etc.), metadata associated with a file modification (e.g., user attribution data, file data, timestamp data, etc.), or any other type of verification data 326. Further details of an example implementation of verification data 326 that need not necessarily comprise a cryptographic signature 222 are provided below with respect to FIG. 4.

FIG. 4 is a block diagram of an example system for performing an example second aspect of an example verification protocol according to some aspects of the present disclosure. A second client computing device 316 can provide a second modification hash 320 to a server computing system 102 based on modification data 218 stored in an unencrypted modified file 224. The second client computing device 316 can further provide to the server computing system 102, in an unencrypted (sometimes referred to as “plaintext”) or server-readable format, stored metadata 428 stored in the unencrypted modified file 224. The second client computing device 316 can further provide, to the server computing system 102, one or more stored signatures 422 stored in the unencrypted modified file 224. The server computing system 102 can perform signature generation 430 to generate one or more signatures 432 based at least in part on the second modification hash 320 and plaintext stored metadata 428. The server computing system 102 can perform a comparison 434 between the signatures 432 and stored signatures 422, and the server computing system 102 can provide yes/no verification data 426 based on the comparison.

A stored signature 422 can be, comprise, be comprised by, or otherwise share one or more properties with a cryptographic signature 222. For example, a stored signature 422 can have any property described herein with respect to a cryptographic signature 222, and vice versa. In some instances, a stored signature 422 can include a cryptographic signature 222 that was stored in an unencrypted modified file 224 by a first client computing device 110 (e.g., before encrypting the unencrypted modified file 224 to generate an encrypted modified file 114). Additional example implementation details of an example system for storing a cryptographic signature 222 in an unencrypted modified file 224 are further provided below with respect to FIG. 5.

In some instances, a server computing system 102 can generate one signature 432 to be compared to one stored signature 422 or many signatures 432 to be compared with many stored signatures 422 associated with a single modification hash 220. For example, in some instances, a server computing system 102 can generate a first signature 432 based on the second modification hash 320 and first stored metadata 428; a second signature 432 based on the second modification hash 320 and second stored metadata 428; and so on. As a non-limiting illustrative example, a server computing system 102 can generate a first signature 432 based at least in part on user data associated with a user associated with the file modification (e.g., user account logged in using the first client computing device 110, etc.), and a second signature 432 based at least in part on file data (e.g., filename, etc.) associated with the file that was modified. In this manner, for instance, a server computing system 102 and second client computing device 316 can use a plurality of separate signatures 432 and stored signatures 422 to separately verify a plurality of subsets of the stored metadata 428 (e.g., subset comprising the user data; subset comprising the file data; etc.). A subset can include, for example, one data item or multiple data items. In some instances, determining that two signatures 422, 432 are identical can serve to verify that all data items used to generate the signatures 422, 432 are identical (e.g., modification data 218, each data item of a subset of stored metadata 428). In some instances, determining that two signatures 422, 432 are not identical can indicate that at least one input used to generate the signature 432 is different from at least one input used to generate the stored signatures 422.

Yes/no verification data 426 can generally include or otherwise represent various types of data. Verification data 426 can include one type or many types of data. Example data types can include Boolean data, binary data, text data, structured data (e.g., JSON, XML, structured error message, etc.), or other data type. In some instances, yes/no verification data 426 can include data (e.g., Boolean data, error code data, or other data type) indicative of whether or not a signature 432 is identical to a stored signature 422 received from the second client computing device. For example, in some instances, a cryptographic transformation function used for generating the modification hash 220, second modification data 320 and signatures 222, 422, 432 can be configured such that a signature 432 will be identical to a stored signature 422 if the stored metadata 428 accurately reflects metadata associated with modification data 218 used to generate the hashes 220, 320, and different from the stored signature 422 if the stored metadata 428 does not accurately reflect metadata associated with the modification data 218. In such instances, a server computing system 102 can send confirmation data (e.g., success message, confirmation message, Boolean value such as “true”, etc.) if the signatures 422, 432 are identical, and can send error data (e.g., error message, warning, Boolean value such as “false,” etc.) if the signatures 422, 432 are not identical.

Stored metadata 428 can generally include or otherwise represent various types of data. Stored metadata 428 can include one type or many types of data. Example data types can include text data, word processing data, or natural language data; numerical data; binary data; structured data (e.g., data object, data table, data row, data column, XML or JSON data, etc.); audio data; image data; video data; or the like.

In some instances, stored metadata 428 can include data to be verified for accuracy or for correct attribution to a file modification associated with modification data 218 used to generate a second modification hash 320. For example, in some instances, an unencrypted working file 224 can include data correlating one or more file modifications (e.g., file modifications indicated by modification data 218) with one or more stored signatures 422 and one or more stored metadata 428 items. In some instances, the stored metadata 428 can include one or more metadata items that were used (or allegedly used, according to the unencrypted file 224) to generate a stored signature 422 based on modification data 218 associated with a file modification and the one or more metadata items. In such instances, the one or more metadata items can be used to generate a signature 432. If the signature 432 matches the stored signature 422, the server computing system 102 can confirm that the stored signature 422 was generated using the one or more metadata items and the modification data 218. As a non-limiting illustrative example, stored metadata 428 used to generate a signature 432 can include user data and timestamp data associated with a file modification (e.g., “thumbs up” interaction; adding, deleting, or editing a comment; adding, deleting, or editing other content, such as a word processing paragraph, spreadsheet row or column, slideshow presentation slide, etc.). As a second non-limiting illustrative example, stored metadata 428 used to generate a signature 432 can include file data (e.g., filename, file path, file identification number, etc.) associated with the current file or file data that was allegedly used to generate a stored signature 422. For example, in some instances, a first signature 432 can be generated based at least in part on user data and timestamp data, and a second signature 432 can be generated based at least in part on file data (e.g., file identification number of the unencrypted modified file 224 that is currently open on the second client computing device 316). In this manner, for instance, a first type of yes/no verification data 426 (e.g., error message or warning indicating that a comment has been improperly tampered with) can be provided if inaccurate user data or timestamp data is improperly attributed to modification data 218, and a second type of yes/no verification data 426 (e.g., informational message indicating that the relevant comment has been copied over from another file context, but is otherwise accurately attributed) can be provided if a current file identifier does not match an original file identifier associated with a file that was originally modified (e.g., commented on, etc.).

Example types of stored metadata 428 can include user data (e.g., username, user identification number, device identification data, login account data, etc.) indicative of a user who performed, requested, or otherwise initiated a file modification; location data associated with a location of the modification (e.g., paragraph number, word or sentence number, row index, column index, page number, slide number, pixel location, video timestamp, delimiter data, etc.) within the file associated with the modification; a timestamp associated with the modification; categorical data describing a type of file modification that was made; device data associated with a device that requested or performed the modification (e.g., internet protocol address, geolocation data, architecture such as hardware data, operating system data, software application data, etc.); or other metadata.

A system for performing signature generation 430 can be or include one or more software, firmware, or hardware components configured to generate a signature 432 based on one or more of a second modification has 320 and metadata 428. In some instances, the signature generation 430 can be performed by one or more components (e.g., processors, etc.) of the server computing system 102.

A signature 432 can be, comprise, be comprised by, or otherwise share one or more properties with a cryptographic signature 222. For example, a signature 432 can have any property described herein with respect to a cryptographic signature 222, and vice versa. In some instances, a signature 432 can include a cryptographic signature 222 that was generated in response to data received from a second client computing device 316 (e.g., a device that did not perform the modification associated with modification data 218 used to generate a second modification hash 320, etc.).

A system for performing a comparison 434 can be or include one or more software, firmware, or hardware components configured to compare a signature 432 to a stored signature 422 to generate verification data 326, 426. In some instances, the comparison 434 can be performed by one or more components (e.g., processors, etc.) of the server computing system 102.

In some instances, a second client computing device 316 can perform one or more actions responsive to receiving yes/no verification data 426. For example, in some instances, a second client computing device 316 may generate a first user output (e.g., graphical user interface display, audio output, etc.) based on the unencrypted modified file 224 according to a first set of rules if the yes/no verification data 426 indicates that all stored metadata 428 is accurate, and can generate a second user output according to a second set of rules if the yes/no verification data 426 indicates that one or more stored metadata 428 items is inaccurate. For example, a first user output can include an output indicative of (e.g., showing, describing, etc.) the verified stored metadata 428 items; modified file content associated with modification data 218; a success message or other indicator that the stored metadata 428 has been verified (e.g., green check mark, etc.); or any other appropriate output. As another example, a second user output can include an output indicative of a verification failure for one or more stored metadata 428 items, such as an error message or warning; a blank area where the stored metadata 428 or modification data 218 is not shown; a first user output, with a strikethrough font or similar visual indicator striking out any stored metadata 428 that could not be verified; or other appropriate output.

In some instances, actions responsive to receiving a yes/no verification data 426 can include additional actions, instead of or in addition to a user display action. For example, in some instances, a second client computing device 316 or server computing system 102 can, responsive to a verification failure, send an email alert to an information technology (IT) or data security administrator (e.g., client-side data security administrator, etc.); automatically change an access control list for a file 108, 114 associated with the verification failure (e.g., eliminate all non-administrator access in order to “freeze” a state of the file 108, 114 for forensic analysis or data security analysis, etc.); apply one or more automatic security rules correlating one or more types of verification failure to one or more actions to be automatically performed responsive to that type of verification failure; etc.

FIG. 5 is a block diagram of an example system for performing an example first aspect of an example verification protocol according to some aspects of the present disclosure. A first client computing device 110 can modify a file and provide a modification hash 220 based on modification data 218 indicative of the modification. In some instances, the first client computing device 110 can also provide client-determined metadata 528a (e.g., in an unencrypted plaintext format, etc.) associated with the file modification. The server can determine various kinds of server-determined metadata 528b. Based at least in part on the modification hash 220 and the server-determined metadata 528b, the server computing system 102 can perform signature generation 430 to generate one or more cryptographic signatures 222. In some instances, the signature generation 430 can be based in part on any client-determined metadata 528a received from the first client computing device 110. The server computing system 102 can provide the server-determined metadata 528b and cryptographic signature(s) 222 to the first client computing device 110. The first client computing device can store the modification data 218, metadata 528a-b, and cryptographic signature(s) 222 in the unencrypted modified file 224. The first client computing device 110 can encrypt the unencrypted modified file 224, and can provide the resulting encrypted modified file 114 to the server computing system 102.

Client-determined metadata 528a can be, comprise, be comprised by, or otherwise share one or more properties with stored metadata 428. For example, client-determined metadata 528a can have any property described herein with respect to stored metadata 428, and vice versa. Client-determined metadata 528a can include, for example, metadata 428 that was determined by a first client device 110 and added to an unencrypted working file 224 by the first client device 110 in association with modification data 218. In such instances, verification data 326 determined based on the client-determined metadata 528a can verify that stored metadata 428 used to generate a signature 432 matches client-determined metadata 528a used to generate a stored signature 422, but might not provide independent server-side verification that the client-determined metadata 528a was accurate when the first client computing device 110 first determined the client-determined metadata 528a. Client-determined metadata 528a is not required. For example, in some implementations, any data that will not be determined by the server computing system 102 can be included in the modification data 218 used to generate a modification hash 220 (thereby verifying that the data accurately reflects data added by the first client computing device 110) or merely excluded from the data used to generate a cryptographic signature 222 (e.g., without providing verification for some types of client-determined metadata 528a).

Server-determined metadata 528b can be, comprise, be comprised by, or otherwise share one or more properties with stored metadata 428. For example, server-determined metadata 528b can have any property described herein with respect to stored metadata 428, and vice versa. Server-determined metadata 528b can include, for example, metadata 428 that is independently determined by a server computing system 102 (e.g., immediately after the server computing system 102 receives the modification hash 220) and subsequently transmitted to the first client computing device 110 to be included in an unencrypted modified file 224. In this manner, for instance, a server computing system 102 can provide independent verification of the accuracy or authenticity of some server-determined metadata 528b. As a non-limiting illustrative example, if a server determines, responsive to receiving a modification hash 220 from a first client computing device 110, that a particular user account is logged in (e.g., to a web-based software-as-a-service account, etc.) using the first client computing device 110 at the time the modification hash 220 is received, then the server computing system 102 can generate a cryptographic signature 222 based at least in part on user data associated with the user account. Continuing the non-limiting illustrative example, the first client computing device 110 can receive the user data as server-determined metadata 528b from the server computing system 102, and can add data correlating the modification data 218, user data, and cryptographic signature 222 in the unencrypted modified file 224. Continuing the non-limiting illustrative example, a second client computing device 316 can retrieve the cryptographic signature 422, user data, and modification data 218 from an unencrypted modified file 224; generate a second modification hash 320 based on the modification data 218 and user data; and receive confirmation from the server computing system 102 that a signature 432 generated based on the user data and second modification hash 320 is identical to a stored cryptographic signature 422 associated with the user data and second modification hash 320. In this manner, for instance, attribution data correlating a particular user account to a file modification (e.g., comment, edit, etc.) made by that user account can be independently verified by a server computing system 102 (e.g., without accessing unencrypted content showing the file modification itself).

### Example Methods

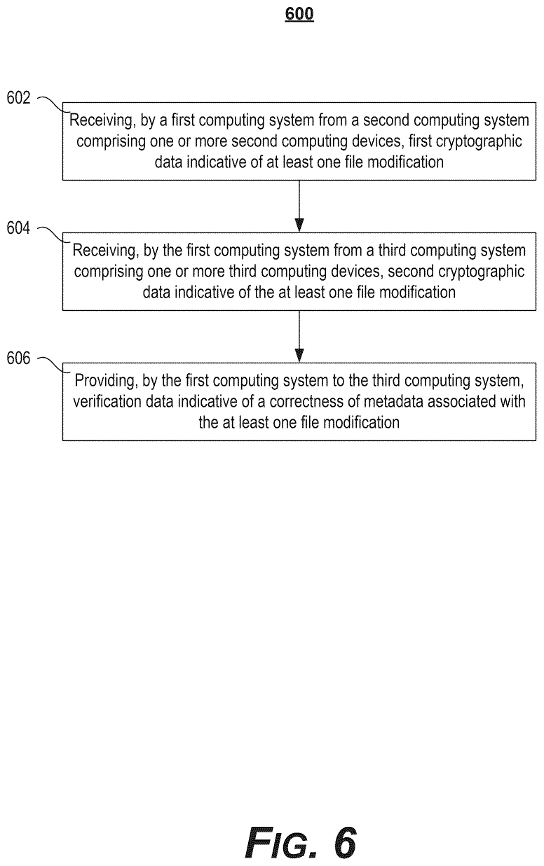

FIG. 6 depicts a flowchart diagram of an example method for verifying metadata associated with a file modification according to example embodiments of the present disclosure. Although FIG. 6 depicts steps performed in a particular order for purposes of illustration and discussion, the methods of the present disclosure are not limited to the particularly illustrated order or arrangement. The various steps of example method 600 can be omitted, rearranged, combined, and/or adapted in various ways without deviating from the scope of the present disclosure.

At 602, example method 600 can include receiving, by a first computing system (e.g., server computing system 102) from a second computing system comprising one or more second computing devices (e.g., first client device 110), first cryptographic data (e.g., modification hash 220) indicative of at least one file modification. In some instances, example method 600 at 602 can include using one or more systems or performing one or more activities described with respect to FIGS. 2 and 5.

At 604, example method 600 can include receiving, by the first computing system from a third computing system comprising one or more third computing devices (e.g., second client computing device 316, additional client computing devices 116, etc.), second cryptographic data (e.g., second modification hash 320, etc.) indicative of the at least one file modification. In some instances, example method 600 at 604 can include using one or more systems or performing one or more activities described with respect to FIGS. 3 and 4.

At 606, example method 600 can include providing, by the first computing system to the third computing system, verification data (e.g., verification data 326) indicative of a correctness of metadata (e.g., stored metadata 428, etc.) associated with the at least one file modification. In some instances, example method 600 at 606 can include using one or more systems or performing one or more activities described with respect to FIGS. 3 and 4.

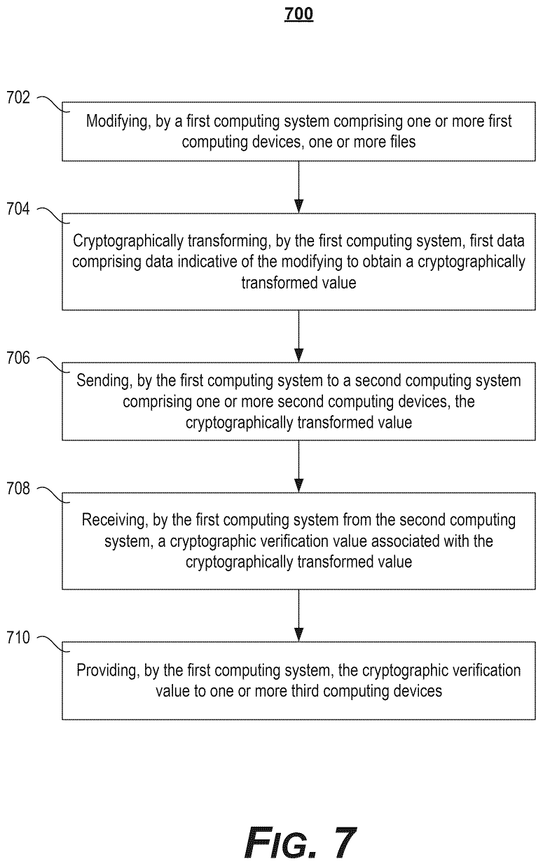

FIG. 7 depicts a flowchart diagram of an example method for modifying a file according to example embodiments of the present disclosure. Although FIG. 7 depicts steps performed in a particular order for purposes of illustration and discussion, the methods of the present disclosure are not limited to the particularly illustrated order or arrangement. The various steps of example method 700 can be omitted, rearranged, combined, and/or adapted in various ways without deviating from the scope of the present disclosure.

At 702, example method 700 can include modifying, by a first computing system comprising one or more first computing devices (e.g., first client computing device 110), one or more files (e.g., encrypted file 108, unencrypted modified file 224, etc.). In some instances, example method 700 at 702 can include using one or more systems or performing one or more activities described with respect to FIGS. 1, 2, and 5.

At 704, example method 700 can include cryptographically transforming (e.g., using a client-side hash system 217), by the first computing system, first data comprising data indicative of the modifying (e.g., modification data 218) to obtain a cryptographically transformed value (e.g., modification hash 220). In some instances, example method 700 at 704 can include using one or more systems or performing one or more activities described with respect to FIGS. 2 and 5.

At 706, example method 700 can include sending, by the first computing system to a second computing system (e.g., server computing system 102) comprising one or more second computing devices, the cryptographically transformed value. In some instances, example method 700 at 706 can include using one or more systems or performing one or more activities described with respect to FIGS. 2 and 5.

At 708, example method 700 can include receiving, by the first computing system from the second computing system, a cryptographic verification value (e.g., cryptographic signature 222) associated with the cryptographically transformed value. In some instances, example method 700 at 708 can include using one or more systems or performing one or more activities described with respect to FIGS. 2 and 5.

At 710, example method 700 can include providing, by the first computing system, the cryptographic verification value to one or more third computing devices (e.g., additional client computing devices 116, etc.). In some instances, example method 700 at 710 can include using one or more systems or performing one or more activities described with respect to FIGS. 2 and 5.

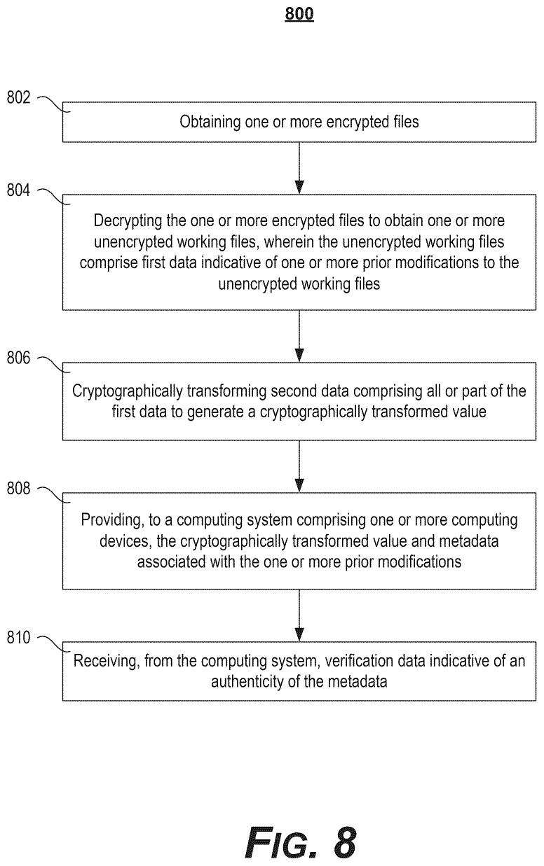

FIG. 8 depicts a flowchart diagram of an example method for receiving metadata verification according to example embodiments of the present disclosure. Although FIG. 8 depicts steps performed in a particular order for purposes of illustration and discussion, the methods of the present disclosure are not limited to the particularly illustrated order or arrangement. The various steps of example method 800 can be omitted, rearranged, combined, and/or adapted in various ways without deviating from the scope of the present disclosure.

At 802, example method 800 can include obtaining (e.g., by a second client computing device 316) one or more encrypted files (e.g., encrypted modified file 114, etc.). In some instances, example method 800 at 802 can include using one or more systems or performing one or more activities described with respect to FIGS. 1, 3, and 4.

At 804, example method 800 can include decrypting the one or more encrypted files to obtain one or more unencrypted working files (e.g., unencrypted modified file 224), wherein the unencrypted working files comprise first data (e.g., modification data 218) indicative of one or more prior modifications to the unencrypted working files. In some instances, example method 800 at 804 can include using one or more systems or performing one or more activities described with respect to FIGS. 3 and 4.

At 806, example method 800 can include cryptographically transforming (e.g., using client-side hash system 217) second data (e.g., modification data 218) comprising all or part of the first data to generate a cryptographically transformed value (e.g., second modification hash 320). In some instances, example method 800 at 806 can include using one or more systems or performing one or more activities described with respect to FIGS. 3 and 4.

At 808, example method 800 can include providing, to a computing system (e.g., server computing system 102) comprising one or more computing devices, the cryptographically transformed value and metadata (e.g., stored metadata 428) associated with the one or more prior modifications. In some instances, example method 800 at 808 can include using one or more systems or performing one or more activities described with respect to FIGS. 3 and 4.

At 810, example method 800 can include receiving, from the computing system, verification data (e.g., verification data 326, yes/no verification data 426, etc.) indicative of an authenticity of the metadata. In some instances, example method 800 at 810 can include using one or more systems or performing one or more activities described with respect to FIGS. 3 and 4.

### Example Computing Systems and Devices

FIG. 9 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 9 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 9 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

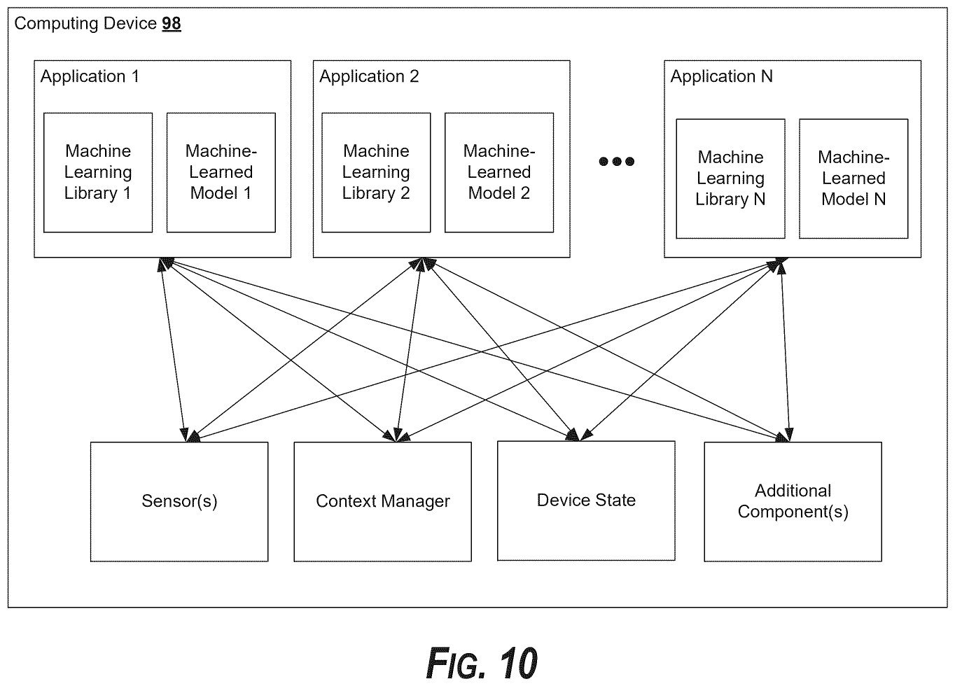

FIG. 10 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 10, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

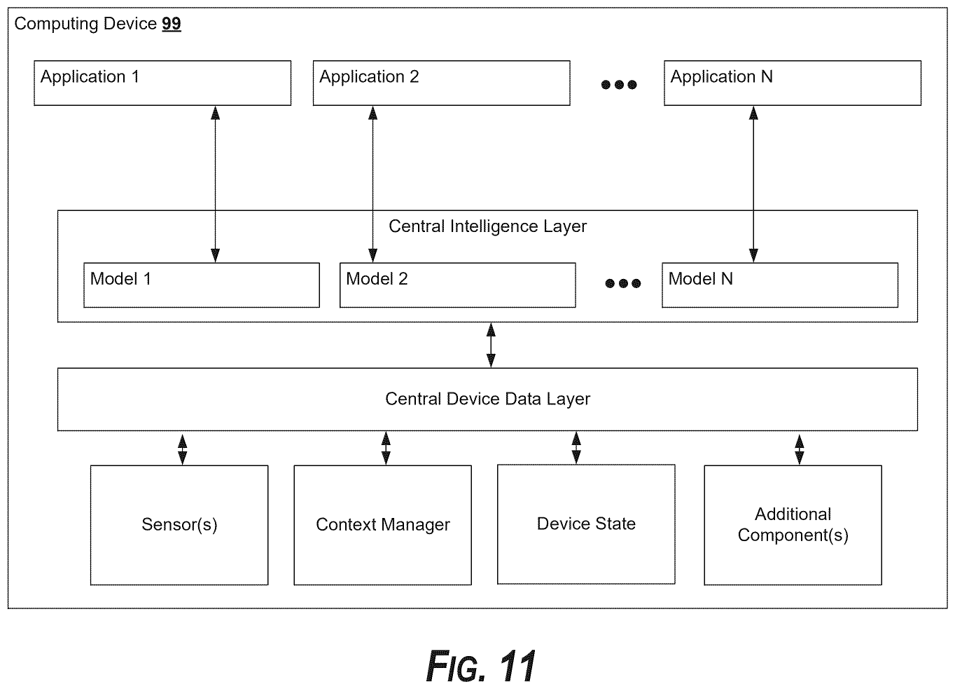

FIG. 11 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 11, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 11, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

As used herein, any claim to an apparatus-implemented or device-implemented (e.g., computer-implemented) method describes a method that can be “used” (e.g., performed, executed, infringed, etc.) by a legal entity or legal person (e.g., corporation, individual human being, etc.) by initiating the method in any manner. For example, initiating can include causing, in any manner, one or more devices to perform the activities of the claimed method. The one or more devices can include, for example, one or more first devices owned by the legal entity or legal person initiating the method; one or more second devices not owned by the legal entity or legal person initiating the method; one or more third devices administered, maintained, or otherwise controlled by the legal entity or legal person initiating the method; and one or more fourth devices not administered, maintained or otherwise controlled by the legal entity or legal person initiating the method. Causing can include any form of causation, including but not limited to but-for causation, substantial factor causation such as independent-sufficient-cause causation, and the like. By way of non-limiting illustrative example, causing a computer to perform an action can include a variety of acts that can be performed by a legal entity, such as providing or causing to be provided a signal (e.g., network signal) or computer-readable instruction (e.g., API instruction, HTML instruction for execution by a browser application, software application, etc.) to cause the computer to perform the action; providing or causing to be provided an input interaction (e.g., user input interaction such as touch screen interaction, button press, keyboard data entry, etc.) to cause the computer to perform the action; installing or causing to be installed, or activating or causing to be activated, or providing or causing to be provided for installation or activation, one or more computer-readable instructions (e.g., in one or more non-transitory computer-readable storage media associated with the computer) that, when executed, cause the computer to perform the action; or any other causal action. Additionally, causing a device to perform an action can include causation (e.g., but-for causation) that may depend on one or more intervening causes. By way of non-limiting illustrative example, causing a computer to perform an action can include providing a first plurality of computer-readable instructions to cause the computer to: perform the claimed action using a second plurality of computer-readable instructions (e.g., web browser, etc.); perform the claimed action responsive to a predetermined user action (e.g., interacting with a “Click to continue” button; selecting a first configuration option of a finite plurality of configuration options; opting into or not opting out of a predetermined protocol comprising the claimed action; etc.); or the like.

Additionally, as used herein, any claim to a device or system describes a device or system that can be “used” by a legal entity or legal person by putting the device or system into action in any manner. As a non-limiting illustrative example, as used herein, any claim to a device or system comprising non-transitory computer-readable media storing instructions that, when executed by one or more devices (e.g., processor devices, computing devices, etc.), cause the one or more devices to perform one or more claimed operations describes a system or device that can be “used” by causing, in any manner (e.g., any manner described above with respect to initiating performance of a method), one or more devices (e.g., devices owned or not owned by a legal person putting the devices into action, etc.) to perform the one or more claimed operations.

What is claimed is:

1. A computer-implemented method, comprising:
modifying, by a first computing system comprising one or more first computing devices, one or more files;
cryptographically transforming, by the first computing system, first data comprising data indicative of the modifying to obtain a cryptographically transformed value;
sending, by the first computing system to a second computing system comprising one or more second computing devices, the cryptographically transformed value;
receiving, by the first computing system from the second computing system, a cryptographic verification value associated with the cryptographically transformed value; and
providing, by the first computing system, the cryptographic verification value to one or more third computing devices.

2. The computer-implemented method of claim 1, wherein providing the cryptographic verification value comprises:
adding, by the first computing system to the one or more files, the cryptographic verification value;
encrypting, by the first computing system, the one or more files to generate one or more encrypted files; and
providing, by the first computing system, the one or more encrypted files to the second computing system, wherein the second computing system comprises one or more server computing devices configured to provide the one or more encrypted files to the one or more third computing devices.

3. The computer-implemented method of claim 1, wherein cryptographically transforming comprises generating a cryptographic hash based on the first data, and the cryptographically transformed value comprises a hash value.

4. The computer-implemented method of claim 1, wherein the cryptographic verification value comprises a cryptographic signature.

5. The computer-implemented method of claim 1, further comprising:
prior to modifying the one or more files, receiving, by the first computing system from the second computing system, one or more first encrypted files; and
decrypting, by the first computing system, the one or more first encrypted files to obtain the one or more files.

6. The computer-implemented method of claim 5, further comprising:
subsequent to modifying the one or more files, encrypting, by the first computing system, the one or more files to generate one or more second encrypted files; and
providing, to the second computing system, the one or more second encrypted files.

7. A first computing system comprising one or more processors and one or more non-transitory computer-readable media storing instructions that are executable by one or more processors to cause the first computing system to perform operations, the operations comprising:
receiving, from a second computing system comprising one or more second computing devices, first cryptographic data indicative of at least one file modification;
receiving, from a third computing system comprising one or more third computing devices, second cryptographic data indicative of the at least one file modification; and
providing, to the third computing system based on the first cryptographic data and second cryptographic data, verification data indicative of a correctness of metadata associated with the at least one file modification.

8. The first computing system of claim 7, wherein the metadata is first metadata, and the operations further comprise:
generating, based at least in part on the first cryptographic data and based at least in part on second metadata, a first cryptographic verification value; and
generating, based at least in part on the second cryptographic data and based at least in part on the first metadata, a second cryptographic verification value;
wherein the verification data comprises at least one of:
the second cryptographic verification value; and
data indicative of a comparison between the second cryptographic verification value and a third cryptographic verification value received from the third computing system.

9. The first computing system of claim 8, wherein the operations further comprise:
receiving, from the second computing system, one or more encrypted files comprising the first cryptographic verification value; and
providing, to the third computing system, the one or more encrypted files;
wherein the third cryptographic verification value is the first cryptographic verification value.

10. The first computing system of claim 7, wherein the metadata comprises data indicative of a user, login account, or second computing device associated with the first cryptographic data.

11. The first computing system of claim 10, wherein the metadata comprises data indicative of a login account identified by the first computing system as being logged in on a second computing device from which the first cryptographic data was received.

12. The first computing system of claim 7, wherein the metadata comprises a timestamp indicative of a time at which the first cryptographic data was received.

13. One or more non-transitory computer-readable media storing instructions that are executable by one or more processors to cause a computing system to perform operations, the operations comprising:
obtaining one or more encrypted files;
decrypting the one or more encrypted files to obtain one or more unencrypted working files, wherein the one or more unencrypted working files comprise first data indicative of one or more prior modifications to the one or more unencrypted working files;
cryptographically transforming second data comprising all or part of the first data to generate a cryptographically transformed value;
providing, to a computing system comprising one or more computing devices, the cryptographically transformed value and metadata associated with the one or more prior modifications; and
receiving, from the computing system, verification data indicative of an authenticity of the metadata.

14. The one or more non-transitory computer-readable media of claim 13, wherein the operations further comprise:
prior to providing the metadata, obtaining the metadata from the one or more unencrypted working files.

15. The one or more non-transitory computer-readable media of claim 13, wherein the operations further comprise:
providing, to the computing system, a cryptographic verification value associated with the one or more modifications, wherein the one or more unencrypted working files comprise the cryptographic verification value.

16. The one or more non-transitory computer-readable media of claim 13, wherein the verification data comprises a first cryptographic verification value, and further comprising:
comparing the first cryptographic verification value to a second cryptographic verification value, wherein the one or more unencrypted working files comprise the second cryptographic verification value.

17. The one or more non-transitory computer-readable media of claim 13, wherein the metadata comprises timestamp data associated with the one or more prior modifications.

18. The one or more non-transitory computer-readable media of claim 13, wherein the metadata comprises data indicative of a user, login account, or second computing device associated with the one or more prior modifications.

19. The one or more non-transitory computer-readable media of claim 18, wherein the metadata comprises data indicative of a user identified by the first data as having initiated the one or more modifications.

20. The one or more non-transitory computer-readable media of claim 13, wherein the one or more unencrypted files comprise at least one of: a word processing file, a spreadsheet file, and a slideshow presentation file.
